(19) United States
(12) Patent Application Publication
(10) Pub. No.: US 2023/0062883 A1
(43) Pub. Date: Mar. 2, 2023

(54) METHODS AND SYSTEMS FOR FACILITATING DIGITAL VOTING

(71) Applicant: Long Jiao, Cupertino, CA (US)

(72) Inventor: Long Jiao, Cupertino, CA (US)

(21) Appl. No.: 17/880,131

(22) Filed: Aug. 3, 2022

Related U.S. Application Data
(60) Provisional application No. 63/271,032, filed on Oct. 22, 2021.
(60) Provisional application No. 63/236,607, filed on Aug. 24, 2021.

(51) Int. Cl. G07C 13/00; H04L 9/08

(52) U.S. Cl. CPC G07C 13/00; H04L 9/0866; G06Q 2230/00

(57) ABSTRACT

The present invention describes systems and methods for facilitating digital voting. It is an object of the present invention to provide a secure digital system wherein voters' identities can be verified and can verify that their votes are recorded correctly. Additionally, this digital voting system reduces the cost and time required for traditional elections. This digital voting system and method comprises online registration, an online voting platform, secured vote encryption, and voter results verification.

### FIELD OF THE INVENTION

The present invention relates generally to a field of data processing. More specifically, the present invention is systems and methods for facilitating digital voting.

### BACKGROUND OF THE INVENTION

Traditional voting systems have several flaws. Traditional voting is expensive, time consuming, and unreliable. The traditional voting process does not provide a secure way to verify participants or voting results. Additionally, individual voters cannot confirm that their votes were counted correctly. Despite the internet being a primary tool of engagement, which could be used to make voting an easier and consistent process, people cannot currently vote online. It is estimated that less than 30% of eligible voters cast a ballot in the presidential primaries, and this percentage of voters is significantly lower for nonpresidential elections. Existing techniques for facilitating voting are deficient regarding several aspects. For instance, current technologies do not secure a vote casted by a voter which may result in misuse of the vote. Furthermore, current technologies do not encrypt the vote casted by a voter which may allow access to the vote and change its characteristics. Furthermore, current technologies do not identify and differentiate the votes casted by different voters. Moreover, current technologies do not enable the voters to verify the votes casted by them when the election results are declared.

The present invention relates generally to a field of data processing. More specifically, the present invention is systems and methods for facilitating digital voting. It is an object of the present invention to provide a secure digital system wherein voters' identities can be verified and can verify that their votes are recorded correctly. Additionally, the digital voting system reduces the cost and time required for elections. This digit voting system comprises online registration, an online voting platform, vote encryption, and voter results verification.

### SUMMARY

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

According to some embodiments, a system for facilitating digital voting is disclosed. Accordingly, the system may include a communication device, a processing device, and a storage device. Further, the communication device may be configured for receiving at least one unique applicant code and user information from at least one user device. Further, the communication device may be configured for transmitting a digital ballot to the at least one user device. Further, the communication device may be configured for receiving a digital vote from at least one user device. Further, the processing device may be communicatively coupled with the communication device. Further, the processing device may be configured for comparing user information with verification information. Further, the processing device may be configured for verifying the user information based on the comparing. Further, the processing device may be configured for generating the digital ballot and a cryptic key based on verifying the user information. Further, processing of the digital vote may include encrypting the digital vote using the cryptic key. Further, the processing device may be configured for generating an encrypted digital vote and confirmation data. Further, the storage device may, the storage device may be configured for retrieving be communicatively coupled with the processing device. Further the verification information associated with at least one unique applicant code. Further, the storage device may be configured for storing the encrypted digital vote and the confirmation data.

According to some aspects, a method for facilitating digital voting is disclosed. Accordingly, the method may include a step of receiving, using a communication device, at least one unique applicant code and user information from at least one user device. Further, the method may include a step of retrieving, using a storage device, verification information associated with at least one unique applicant code. Further, the method may include a step of comparing, using a processing device, the user information with the verification information. Further, the method may include a step of verifying, using the processing device, the user information based on the comparing. Further, the method may include a step of generating, using the processing device, a digital ballot and a cryptic key based on the verifying of the user information. Further, the method may include a step of transmitting, using the communication device, the digital ballot to the at least one user device. Further, the method may include a step of receiving, using the communication device, the digital vote from the at least one user device. Further, the method may include a step of processing, using the processing device, the digital vote. Further, the method may include a step of generating, using the processing device, confirmation data and an encrypted digital vote. Further, the method may include a step of storing, using a storage device, the encrypted digital vote and the confirmation data.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 shows a flowchart of a method to facilitate digital voting, in accordance with some embodiments.

FIG. 3 is a flowchart of a method for facilitating registering an applicant to cast a digital vote, in accordance with some embodiments.

FIG. 4 is a flowchart of a method for facilitating encrypting of a digital vote, in accordance with some embodiments.

FIG. 5 is a flowchart of a method for facilitating verifying of digital vote results, in accordance with some embodiments.

FIG. 6 is the continuation flowchart of FIG. 5.

FIG. 7 is a flowchart of a method for facilitating securing a digital vote using face recognition, in accordance with some embodiments.

FIG. 8 is a block diagram of a computing device for implementing the methods disclosed herein, in accordance with some embodiments.

### DETAIL DESCRIPTIONS OF THE INVENTION

All illustrations of the drawings are for the purpose of describing selected versions of the present invention and are not intended to limit the scope of the present invention.

The present invention, herein referred to as, “Verifiable Digital Voting System”, is a system and method for facilitating digital voting. There are four parties who will participate in the verifiable digital voting system: election registration, voting platform provider, individual voters, and verifiers. The election registration described in the present invention has voter information and designs actual election questions. They will also run a voter authentication system during the election. The voting platform provider described in the present invention will receive the actual vote results. The individual voters described in the present invention will vote on the voting platform and verify the recorded results after the completion of the election. The verifiers described the present invention receive voter information and participation from the election registration. Additionally, the verifiers receive the entire voting results with Verification ID from the voting platform.

Below is an outline in sequential order of the verifiable digital voting system.
1. Pre-Voting Phase
   a. Individual voters will update registrar with email, phone number, along with other contact information, and indicate which one they prefer to use for vote authentication.
   b. The Registrar and Voting Platform generate a pair of private-public keys for the coming election. These keys are for encrypting voter results, so they can be generated privately.
   c. Registrar designs election questions and uploads them to Voting Platform.
   d. Registrar updates Voting Platform with the list of Voting Codes to voting platform. Voting Code is hard to guess but easy to enter, like GUID (global unique identifier.)
   e. Voting Platform generates an internal salt for each Voting Code. Here, internal salts are a random string of number to generate a verification number. This random number cannot be predicted by the individual voter. This is similar to a GUID (global unique identifier.)
   f. The election registration designs a ballot which contains a ballot ID. This ID is unique to each individual voter
   g. Registrar delivers, through email or other similar digital notification, a Voting Code described in 1. d and a voting link to each registered voter. The Voting Code can only be used for one election only or for a certain period as set per the parameters of the election.
   h. The Registrar system is ready to authenticate user.
2. Voting Phase
   a. Voter visits voting link provided in 1. g during voting period using a client (such as a browser or App).
   b. Voter provides Voting Code provided in 1. g.
   c. Voting Platform sends a request to Registrar System with Voting Code.
   d. Registrar System generates an authentication pin, wherein a pin is a random generation of number.
   e. Registrar System sends the authentication pin to Voting Platform.
   f. Registrar System sends the authentication pin to voters through email or other similar digital notification,
   g. Voter enters the pin they received through email or text message.
   h. Voting Platform authorizes voter after comparing the pin entered by voter and that received from Registrar System.
   i. Voter's client receives ballot which contains ballot ID and public keys from Registrar and Voting Platform.
   j. Voter votes and submits the vote.
   k. Voter's client generates a random string. And it encrypts the vote by appending 1. Ballot ID received in 2. d, and 2. the random string, to each vote and encrypting with both public keys received in 2.i.
   l. Voting Platform sends a Confirmation Code to voter. The Confirmation Code is digest of the Voting Code, vote record and the salts generated in 1. e. Registrar will not know the owner of each Confirmation Code.
   m. Voting Platform stores encrypted vote record and Confirmation Code. Voting Platform does not have the decryption key for Registrar's public key, so the Voting Platform won't know election results before the election ends.
   n. Voter records the Confirmation Code for future verification.
3. Post-Voting Phase
   a. Voting Platform stops accepting or authorizing new ballots or requests at a specific time designated by the election.
   b. Registrar sends its private key to Voting Platform to decrypt vote records.
   c. Voting Platform decrypts vote records using its own private key and the key received in 3. b.
   d. Voting Platform counts voting results and publishes the results.
   e. Voting Platform sends the list of participating Vote Codes to Registrar.
   f. Voting Platform publishes the list of Confirmation Code and decrypted vote records.
   g. Eligible Verifier downloads the list in 3. f, so they can verify the final results matches the published vote records.
   h. Eligible Verifier requests the list of eligible voters rolls from Registrar, so they can verify the total number of vote records matches the number of participated voters.
   i. Individual Voter checks the published list with Confirmation Code and verifies the vote result.
   j. Eligible Verifier samples voters to verify 1. participation information, 2. If participated, verify the record is correct. (Verifier does not have to ask what the voter voted for, but just to ask the result of 3.i)

In the outline of the verifiable digital voting system, no facility can match voters to their votes. Thus, voter privacy is kept. Vote results are encrypted with both keys from Registrar and Voting Platform. Before voting ends and before the Registrar shares its private key with Voting Platform, no facility can decrypt Voting Records. Because the encryption contains a voter side generated random string, it's nearly impossible to guess the voting records by enumerating all possible votes. This process makes the election easily verifiable—voters can verify their votes are counted properly, and Registrar can verify who actually casted the ballot, even though Registrar doesn't know how the voter voted. And at the same time no single entity knows both voter information and their voting results besides individual voter, so voter privacy is also protected. In a preferred embodiment of the present invention, when there is voter fraud, the email or text message sent to fraudulent voter can be a clue to law enforcement to investigate voter fraud.

This process is also much cheaper than traditional voting since voters can vote through internet and the process does not need any poll worker.

In one embodiment of the present invention, the voting platform maintains a map between user (Voting Code) and the voting record (Confirmation Code), so when a voter regrets, the previous record can be invalidated. To keep voters' privacy, the map between Voting Code and Confirmation Code should be removed when the polling ends. In one embodiment of the present invention, the votes are not encrypted to allow verify the validity of each vote.

Although the invention has been explained in relation to its preferred embodiment, it is to be understood that many other possible modifications and variations can be made without departing from the spirit and scope of the invention

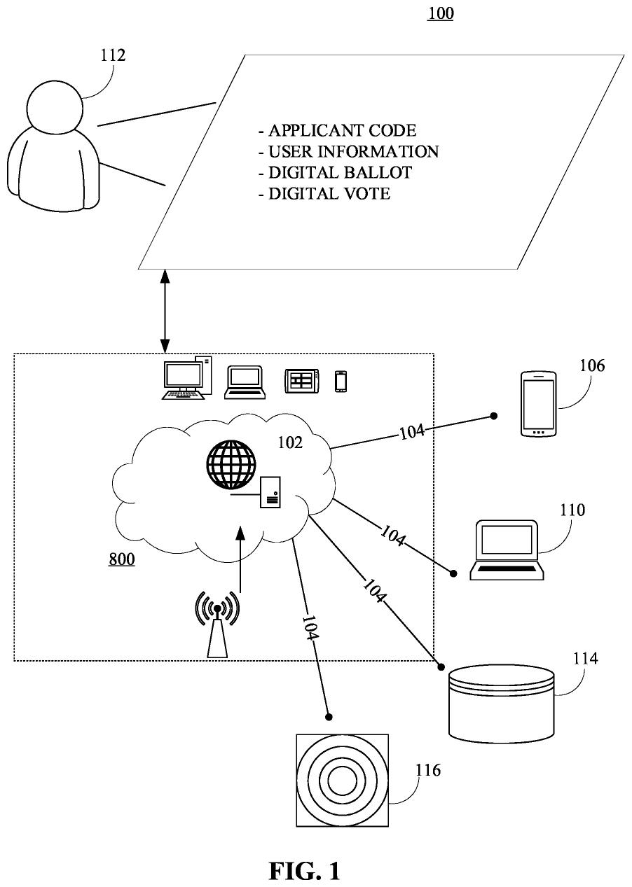

Referring now to figures, FIG. 1 is an illustration of an online platform 100 consistent with various embodiments of the present disclosure. By way of non-limiting example, the online platform 100 for facilitating assessment of well-being of a user based on feedback may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, and sensors 116 over a communication network 104, such as, but not limited to, the Internet. Further, users of the online platform 100 may include relevant parties such as, but not limited to, end-users, service providers, managers, and administrators. Accordingly, in some instances, electronic devices operated by the one or more relevant parties may be in communication with the online platform 100.

A user 112, such as the one or more relevant parties, may access the online platform 100 through a web-based software application or browser. The web-based software application may be embodied as, for example, but not be limited to, a website, a web application, a desktop application, and a mobile application compatible with a computing device 800.

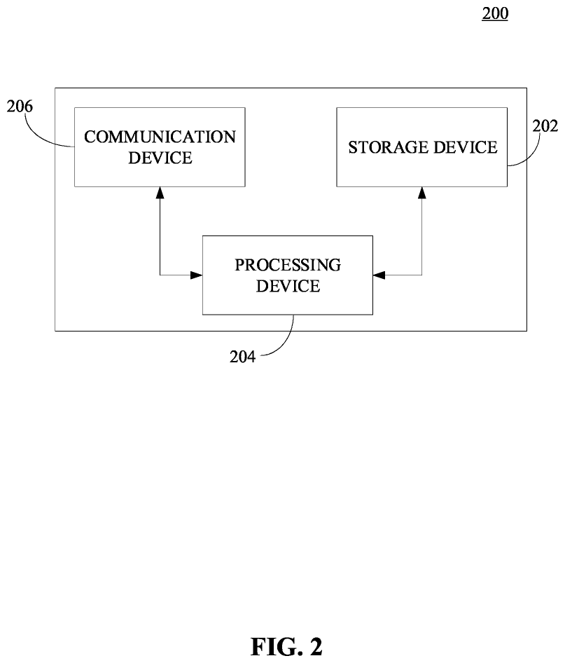

FIG. 2 is a block diagram 200 of a system for facilitating digital voting, in accordance with some embodiments. Accordingly, the system may include a communication device 206 configured for receiving a request from at least one first user device associated with at least one first user. Further, the at least one first user may include an individual, an institution, and an organization. Further, the at least one first user device may include a smartphone, a tablet, a laptop, a personal computer, and so on. Further, the at least one second user may include an individual, an institution, and an organization. Further, the communication device 206 may be configured for transmitting a digital voting system to at least one second user device. Further, the at least one second user device may include a smartphone, a tablet, a laptop, a personal computer, and so on. Further, the communication device 206 may be configured digital voting system to at least one of the at least one first user device and the at least one second user device. Further, the system may include a storage device 202 configured for retrieving digital voting system. 202 may be configured for storing the at least one voter response on the blockchain.

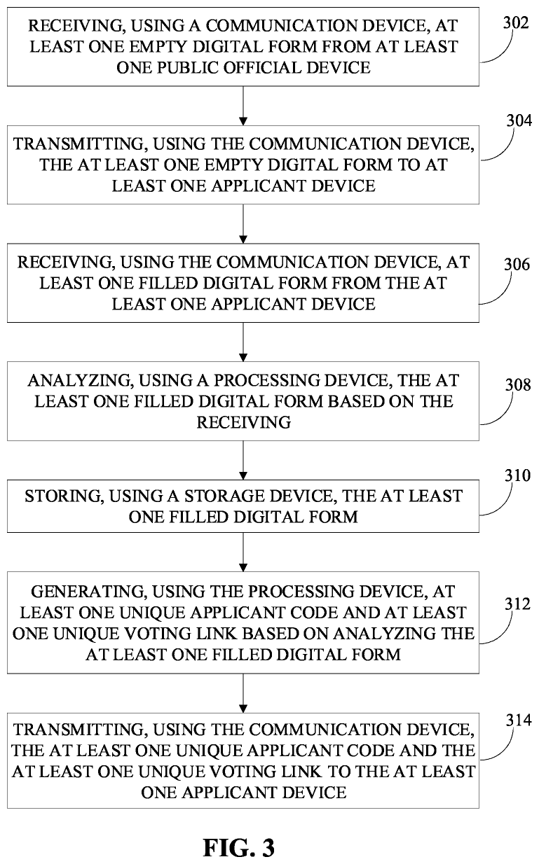

With reference to FIG. 3, a system consistent with an embodiment of the disclosure may include receiving, using a communication device, at least one empty digital form from at least one public official device 302. The system may include transmitting, using the communication device, the at least one empty digital form to at least one applicant device 304. The system may include receiving, using the communication device, at least one filled digital form from the at least one applicant device 306. The system may include analyzing, using a processing device, the at least one filled digital form based on the receiving 308. The system may include storing, using a storage device, the at least one filled digital form 310. The system may include generating, using the processing device, at least one unique applicant code and at least one unique voting link based on analyzing the at least one filled digital form 312. The system may include transmitting, using the communication device, the at least one unique applicant code and the at least one unique voting link to the at least one applicant device 314.

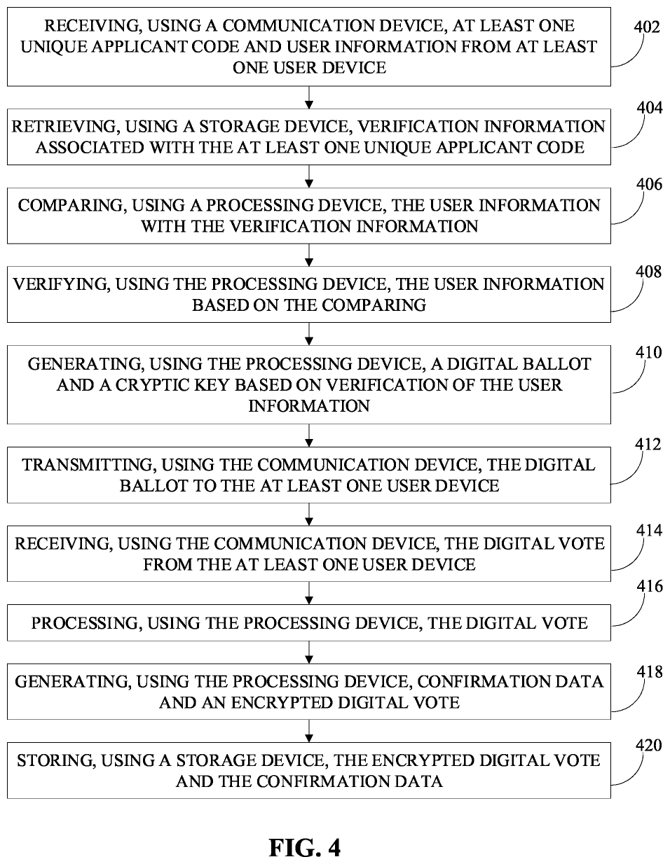

With reference to FIG. 4, a system consistent with an embodiment of the disclosure may include receiving, using a communication device, at least one unique applicant code and user information from at least one user device 402. The system may include retrieving, using a storage device, verification information associated with the at least one unique applicant code 404. The system may include comparing, using a processing device, the user information with the verification information 406. The system may include verifying, using the processing device, the user information based on the comparing 408. The system may include generating, using the processing device, a digital ballot and a cryptic key based on verification of the user information 410. The system may include transmitting, using the communication device, the digital ballot to the at least one user device 412. The system may include receiving, using the communication device, the digital vote from the at least one user device 414. The system may include processing, using the processing device, the digital vote 416. The system may include generating, using the processing device, confirmation data and an encrypted digital vote 418. The system may include storing, using a storage device, the encrypted digital vote and the confirmation data 420.

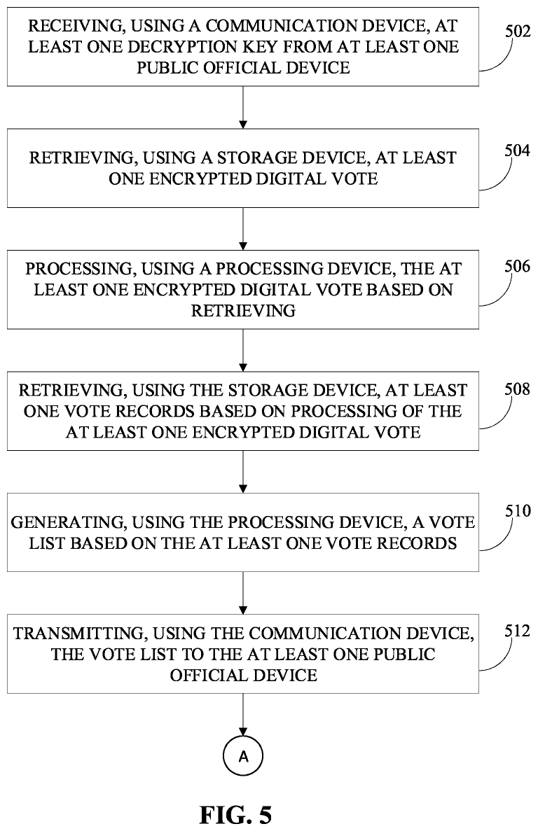

With reference to FIG. 5, a system consistent with an embodiment of the disclosure may include receiving, using a communication device, at least one decryption key from at least one public official device 502. The system may include retrieving, using a storage device, at least one encrypted digital vote 504. The system may include processing, using a processing device, the at least one encrypted digital vote based on retrieving 506. The system may include retrieving, using the storage device, at least one vote records based on processing of the at least one encrypted digital vote 508. The system may include generating, using the processing device, a vote list based on the at least one vote records 510. The system may include transmitting, using the communication device the vote list to the at least one public official device 512.

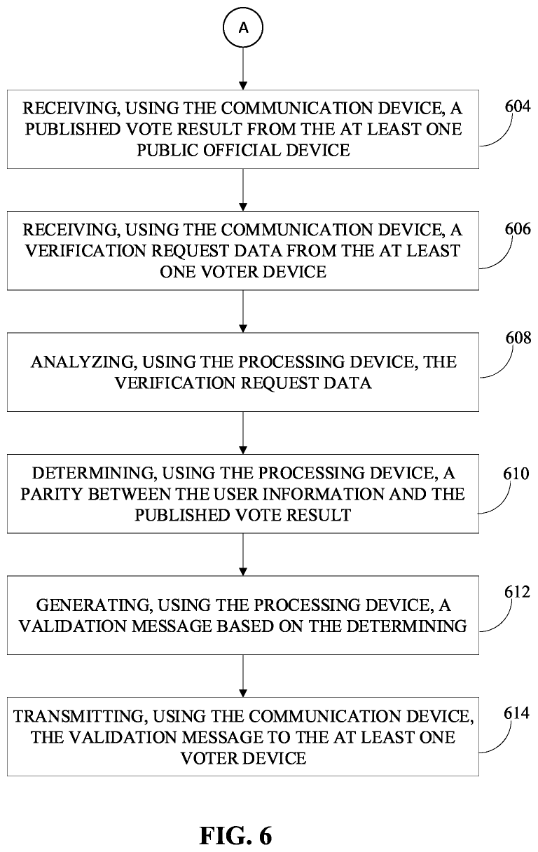

With reference to FIG. 6, a system consistent with an embodiment of the disclosure may include receiving, using the communication device, a published vote result from the at least one public official device 604. The system may include receiving, using the communication device, a verification request data from the at least one voter device 606. The system may include analyzing, using the processing device, the verification request data 608. The system may include determining, using the processing device, a parity between the user information and the published vote result 610. The system may include generating, using the processing device, a validation message based on the determining 612. The system may include transmitting, using the communication device the validation message to the at least one voter device 614.

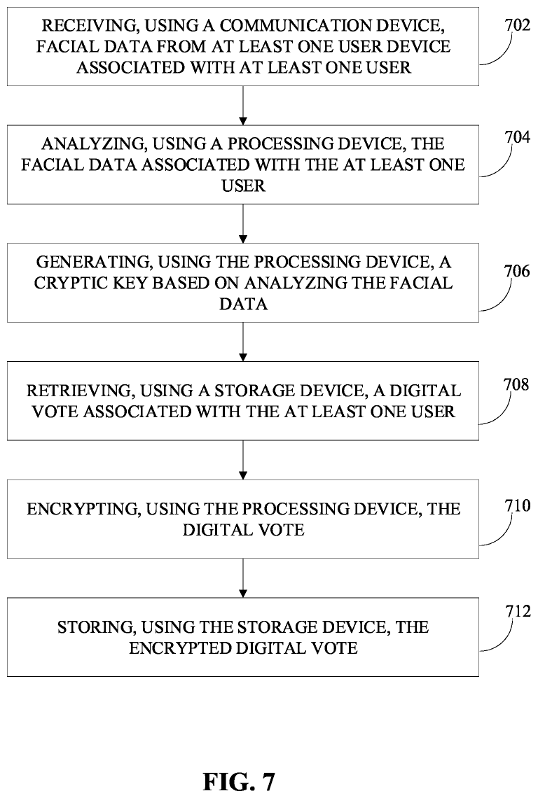

With reference to FIG. 7, a system consistent with an embodiment of the disclosure may include receiving, using a communication device, facial data from at least one user device associated with at least one user 702. The system may include analyzing, using a processing device, the facial data associated with the at least one user 704. The system may include generating, using the processing device, a cryptic key based on analyzing the facial data 706. The system may include retrieving, using a storage device, a digital vote associated with the at least one user 708. The system may include encrypting, using the processing device, the digital vote 710. The system may include storing, using the storage device, the encrypted digital vote 712.

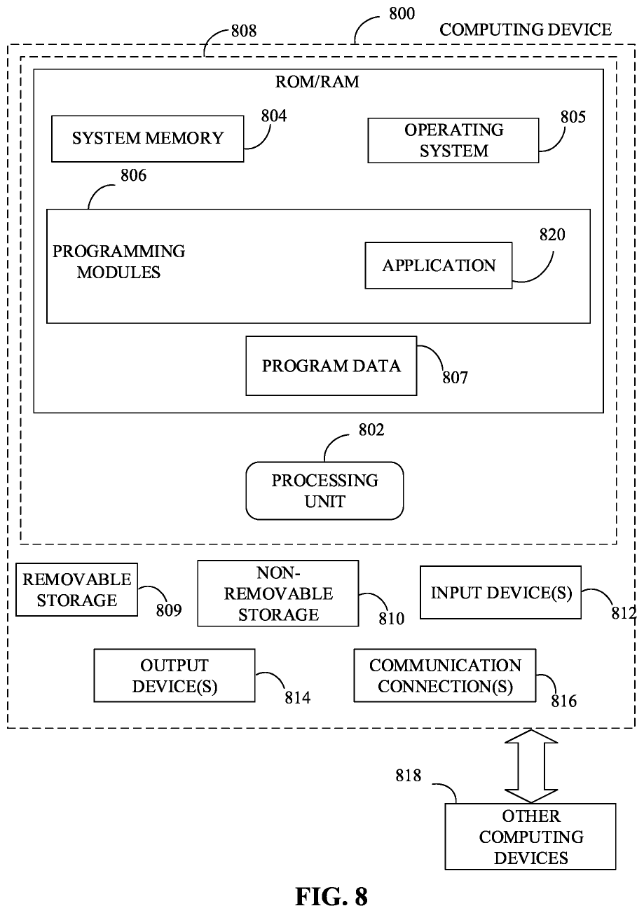

With reference to FIG. 8, a system consistent with an embodiment of the disclosure may include a computing device or cloud service, such as computing device 800. In a basic configuration, computing device 800 may include at least one processing unit 802 and a system memory 804. Depending on the configuration and type of computing device, system memory 804 may comprise, but is not limited to, volatile (e.g. random-access memory (RAM)), non-volatile (e.g. read-only memory (ROM)), flash memory, or any combination. System memory 804 may include operating system 805, one or more programming modules 806, and may include a program data 807. Operating system 805, for example, may be suitable for controlling computing device 800's operation. In one embodiment, programming modules 806 may include an image-processing module, machine learning module, and/or image classifying module. Furthermore, embodiments of the disclosure may be practiced in conjunction with a graphics library, other operating systems, or any other application program and is not limited to any particular application or system. This basic configuration is illustrated in FIG. 8 by those components within a dashed line 808.

Computing device 800 may have additional features or functionality. For example, computing device 800 may also include additional data storage devices (removable and/or non-removable) such as, for example, magnetic disks, optical disks, or tape. Such additional storage is illustrated in FIG. 8 by a removable storage 809 and a non-removable storage 810. Computer storage media may include volatile and nonvolatile, removable, and non-removable media implemented in any method or technology for storage of information, such as computer-readable instructions, data structures, program modules, or other data. System memory 804, removable storage 809, and non-removable storage 810 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 800. Any such computer storage media may be part of device 500. Computing device 800 may also have input device(s) 812 such as a keyboard, a mouse, a pen, a sound input device, a touch input device, a location sensor, a camera, a biometric sensor, etc. Output device(s) 814 such as a display, speakers, a printer, etc. may also be included. The aforementioned devices are examples and others may be used.

Computing device 800 may also contain a communication connection 816 that may allow device 800 to communicate with other computing devices 818, such as over a network in a distributed computing environment, for example, an intranet or the Internet. Communication connection 816 is one example of communication media. Communication media may typically be embodied by computer-readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer-readable media as used herein may include both storage media and communication media.

As stated above, a number of program modules and data files may be stored in system memory 804, including operating system 805. While executing on processing unit 802, programming modules 806 (e.g., application 820 such as a media player) may perform processes including, for example, one or more stages of methods, algorithms, systems, applications, servers, databases as described above. The aforementioned process is an example, and processing unit 802 may perform other processes. Other programming modules that may be used in accordance with embodiments of the present disclosure may include sound encoding/decoding applications, machine learning application, acoustic classifiers, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general-purpose graphics processor-based systems, multiprocessor systems, microprocessor-based or programmable consumer electronics, application-specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer-readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid-state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the invention has been explained in relation to its preferred embodiment, it is to be understood that many other possible modifications and variations can be made without departing from the spirit and scope of the invention.

What is claimed is:

1. A system for facilitating a verifiable digital voting system, comprising:
a communication device configured for receiving at least one empty digital form from at least one public official device;
the communication device configured for transmitting the at least one empty digital form to at least one applicant device;
a processing device analyzing the at least one filled digital form based on the receiving;
the processing device generating at least one unique applicant code and at least one unique voting link based on analyzing the at least one filled digital form;
the communication device configured for transmitting the at least one unique applicant code and the at least one unique voting link to the at least one applicant device.

2. The system for facilitating a verifiable digital voting system of claim 1, further comprising:
the communication device configured for receiving at least one unique applicant code and user information from at least one user device;
a storage device configured for retrieving verification information associated with the at least one unique applicant code;
the processing device configured for comparing the user information with the verification information;
the processing device configured for verifying the user information based on the comparing;
the processing device configured for generating using the processing device, a digital ballot and a cryptic key based on verification of the user information;
the communication device configured for transmitting the digital ballot to the at least one user device;
the communication device configured for receiving the digital vote from the at least one user device;
the processing device configured for processing the digital vote;
the processing device configured for generating confirmation data and an encrypted digital vote;
the storing device configured for storing the encrypted digital vote and the confirmation data.

3. The systems for facilitating a verifiable digital voting system of claim 2, further comprising:
the communication device configured for receiving at least one decryption key from at least one public official device;
the storage device configured for retrieving at least one encrypted digital vote;
the processing device configured for processing at least one vote records based on processing of the at least one encrypted digital vote;
the storage device configured for retrieving at least one vote records based on processing of the at least one encrypted digital vote;
the processing device configured for generating a vote list based on the at least one vote records;
the communication device configured for transmitting the vote list to the at least one public official device.

4. The system for facilitating a verifiable digital voting system of claim 3, further comprising:
the communication device configured for receiving a published vote result from the at least one public official device;
the communication device configured for receiving a verification request data from the at least one voter device;
the processing device configured for analyzing the verification request data;
the processing device configured for determining using the processing device, a parity between the user information and the published vote result;
the processing device configured for generating a validation message based on the determining;
the communication device configured for transmitting the validation message to the at least one voter device.

5. The systems for facilitating a verifiable digital voting system of claim 4, further comprising:
the communication device configured for receiving facial data from at least one user device associated with at least one user;
the processing device configured for analyzing the facial data associated with the at least one user;
the processing device configured for generating a cryptic key based on analyzing the facial data;
the storage device configured for retrieving a digital vote associated with the at least one user;
the processing device configured for encrypting the digital vote;
the storage device configured for storing the encrypted digital vote.

6. The system for facilitating a verifiable digital voting system of claim 2, further comprising:
the communication device configured for receiving at least one decryption key from at least one public official device;
the storage device configured for retrieving at least one encrypted digital vote;
the processing device configured for processing at least one vote records based on processing of the at least one digital vote;
the storage device configured for retrieving at least one vote records based on processing of the at least one digital vote;
the processing device configured for generating a vote list based on the at least one vote records;
the communication device configured for transmitting the vote list to the at least one public official device.

7. The system for facilitating a verifiable digital voting system of claim 6, further comprising:
the communication device configured for receiving a published vote result from the at least one public official device;
the communication device configured for receiving a verification request data from the at least one voter device;
the processing device configured for analyzing the verification request data;
the processing device configured for determining using the processing device, a parity between the user information and the published vote result;
the processing device configured for generating a validation message based on the determining;
the communication device configured for transmitting the validation message to the at least one voter device.

8. The system for facilitating a verifiable digital voting system of claim 7, further comprising:
the communication device configured for receiving facial data from at least one user device associated with at least one user;
the processing device configured for analyzing the facial data associated with the at least one user;
the processing device configured for generating a cryptic key based on analyzing the facial data;
the storage device configured for retrieving a digital vote associated with the at least one user;
the storage device configured for storing the digital vote.

9. A method for facilitating a verifiable digital voting system comprising:
receiving, using a communication device, at least one empty digital form from at least one public official device;
transmitting, using the communication device, the at least one empty digital form to at least one applicant device;
receiving, using the communication device, at least one filled digital form from the at least one applicant device;
analyzing, using a processing device, the at least one filled digital form based on the receiving;
storing, using a storage device, the at least one filled digital form;
generating, using the processing device, at least one unique applicant code and at least one unique voting link based on analyzing the at least one filled digital form;
transmitting, using the communication device, the at least one unique applicant code and the at least one unique voting link to the at least one applicant device.

10. The method for facilitating a verifiable digital voting system of claim 9, further comprising:
receiving, using a communication device, at least one unique applicant code and user information from at least one user device;
retrieving, using a storage device, verification information associated with the at least one unique applicant code;
comparing, using a processing device, the user information with the verification information;
verifying, using the processing device, the user information based on the comparing;
generating, using the processing device, a digital ballot and a cryptic key based on verification of the user information;
transmitting, using the communication device, the digital ballot to the at least one user device;
receiving, using the communication device, the digital vote from the at least one user device;
processing, using the processing device, the digital vote;
generating, using the processing device, confirmation data and an encrypted digital vote;
storing, using a storage device, the encrypted digital vote and the confirmation data.

11. The method for facilitating a verifiable digital voting system of claim 10, further comprising:
receiving, using a communication device, at least one decryption key from at least one public official device;
retrieving, using a storage device, at least one encrypted digital vote;
a processing device, the at least one encrypted digital vote based on retrieving;
retrieving, using the storage device, at least one vote records based on processing of the at least one encrypted digital vote;
generating, using the processing device, a vote list based on the at least one vote records;
transmitting, using the communication device the vote list to the at least one public official device.

12. The method for facilitating a verifiable digital voting system of claim 11, further comprising:
receiving, using the communication device, a published vote result from the at least one public official device;
receiving, using the communication device, a verification request data from the at least one voter device;
analyzing, using the processing device, the verification request data;
determining, using the processing device, a parity between the user information and the published vote result;
generating, using the processing device, a validation message based on the determining;
transmitting, using the communication device the validation message to the at least one voter device.

13. The method for facilitating a verifiable digital voting system of claim 12, further comprising:
receiving, using a communication device, facial data from at least one user device associated with at least one user;
analyzing, using a processing device, the facial data associated with the at least one user;
generating, using the processing device, a cryptic key based on analyzing the facial data;
include retrieving, using a storage device, a digital vote associated with the at least one user;
encrypting, using the processing device, the digital vote;
storing, using the storage device, the encrypted digital vote.

14. The method for facilitating a verifiable digital voting system of claim 10, further comprising:
retrieving, using a storage device, at least one digital vote;
a processing device, the at least one digital vote based on retrieving;
retrieving, using the storage device, at least one vote records based on processing of the at least one digital vote;
generating, using the processing device, a vote list based on the at least one vote records;
transmitting, using the communication device the vote list to the at least one public official device.

15. The method for facilitating a verifiable digital voting system of claim 14, further comprising:
receiving, using the communication device, a published vote result from the at least one public official device;
receiving, using the communication device, a verification request data from the at least one voter device;
analyzing, using the processing device, the verification request data;
determining, using the processing device, a parity between the user information and the published vote result;
generating, using the processing device, a validation message based on the determining;
transmitting, using the communication device the validation message to the at least one voter device.

16. The method for facilitating a verifiable digital voting system of claim 15, further comprising:
receiving, using a communication device, facial data from at least one user device associated with at least one user;
analyzing, using a processing device, the facial data associated with the at least one user;
generating, using the processing device, a cryptic key based on analyzing the facial data;
include retrieving, using a storage device, a digital vote associated with the at least one user;
storing, using the storage device, the digital vote.
